(19) United States
(12) Patent Application Publication
(10) Pub. No.: US 2022/0029164 A1
(43) Pub. Date: Jan. 27, 2022

(54) NONAQUEOUS ELECTROLYTE SECONDARY BATTERY AND NONAQUEOUS ELECTROLYTIC SOLUTION

(71) Applicant: Panasonic Intellectual Property Management Co., Ltd., Osaka-shi, Osaka (JP)

(72) Inventor: Yuanlong Zhong, Osaka (JP)

(73) Assignee: Panasonic Intellectual Property Management Co., Ltd., Osaka-shi, Osaka (JP)

(21) Appl. No.: 17/296,473

(22) PCT Filed: Dec. 4, 2019
(86) PCT No.: PCT/JP2019/047411

§ 371 Date: May 24, 2021

(30) Foreign Application Priority Data
Dec. 6, 2018 (JP) 2018-229164

(51) Int. Cl. H01M 4/587; H01M 10/0567; H01M 10/0525

(52) U.S. Cl. CPC H01M 4/587; H01M 2004/021; H01M 10/0525; H01M 10/0567

(57) ABSTRACT

A non-aqueous electrolyte secondary battery including a positive electrode, a negative electrode, a separator interposed between the positive electrode and the negative electrode, and a non-aqueous electrolyte. The negative electrode includes a graphite. The graphite has a BET specific surface area of 3 m²/g or less. The non-aqueous electrolyte includes a silyl compound represented by a formula (1): (R1R2R3Si—O)ₘ-M=(O)ₙ. In the formula (1), M is P, B or S, n is 0, 1 or 2, m is 2 or 3, and each of R1 to R3 is independently an alkyl group, a fluoroalkyl group, an alkenyl group, a fluoroalkenyl group, an aryl group, a fluoroaryl group, or a hydrogen atom.

### TECHNICAL FIELD

The present invention relates to an improvement of a non-aqueous electrolyte secondary battery including a negative electrode including a graphite.

### BACKGROUND ART

Non-aqueous electrolyte secondary batteries, particularly lithium ion secondary batteries, because of their high voltage and high energy density, have been expected as a promising power source for small consumer applications, power storage devices, and electric cars.

Patent Literature 1 discloses using a graphite having a small specific surface area in the negative electrode, thereby to improve the cycle characteristics of the battery. By reducing the specific surface area of the graphite, the side reaction between the graphite and the non-aqueous electrolyte can be controlled, which is considered to contribute to the improvement in cycle characteristics.

### CITATION LIST

### Patent Literature

[PTL 1] Japanese Laid-Open Patent Publication No. H11-199213

### SUMMARY OF INVENTION

On the other hand, when the specific surface area of the graphite is reduced, due to the increase in the intercalation/deintercalation amount of Li ions per unit area and other reasons, a surface film is thickly formed on the graphite, and the battery internal resistance tends to increase.

In view of the above, one aspect of the present invention relates to a non-aqueous electrolyte secondary battery, including: a positive electrode, a negative electrode, a separator interposed between the positive electrode and the negative electrode, and a non-aqueous electrolyte, wherein the negative electrode includes a graphite, the graphite has a BET specific surface area of 3 m²/g or less, the non-aqueous electrolyte includes a silyl compound represented by a formula (1): (R1R2R3Si—O)ₘ-M=(O)ₙ, in the formula (1), M is P, B or S, n is 0, 1 or 2, m is 2 or 3, and each of R1 to R3 is independently an alkyl group, a fluoroalkyl group, an alkenyl group, a fluoroalkenyl group, an aryl group, a fluoroaryl group, or a hydrogen atom.

Another aspect of the present invention relates to a non-aqueous electrolyte for a secondary battery including a negative electrode including a graphite, the non-aqueous electrolyte including: a silyl compound represented by a formula (1): (R1R2R3Si—O)ₘ-M=(O)ₙ, in the formula (1), M is P, B or S, n is 0, 1 or 2, m is 2 or 3, and each of R1 to R3 is independently an alkyl group, a fluoroalkyl group, an alkenyl group, a fluoroalkenyl group, an aryl group, a fluoroaryl group, or a hydrogen atom.

According to the present invention, the increase in the battery internal resistance can be suppressed when a graphite having a small specific surface area is used.

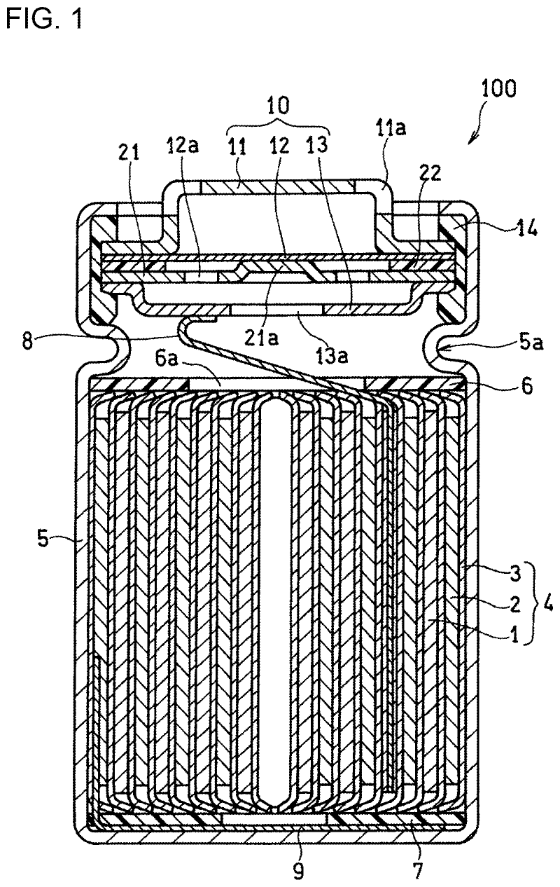

### BRIEF DESCRIPTION OF DRAWING

[FIG. 1] A vertical cross-sectional view of a non-aqueous electrolyte secondary battery according to one embodiment of the present invention.

### DESCRIPTION OF EMBODIMENTS

A non-aqueous electrolyte secondary battery according to an embodiment of the present invention includes a positive electrode, a negative electrode, a separator interposed between the positive electrode and the negative electrode, and a non-aqueous electrolyte. The negative electrode includes a graphite, and the graphite has a BET specific surface area of 3 m²/g or less. When the BET specific surface area of the graphite is small as above, the side reaction between the graphite and the non-aqueous electrolyte is suppressed, which can lead to improved cycle characteristics. On the other hand, the intercalation/deintercalation amount of Li ions per unit area of the graphite surface increases, resulting in a thick surface film formed on the graphite surface. The resistance of the negative electrode rises, also when a substance (e.g., LiF) produced through a side reaction at the positive electrode migrates toward the negative electrode and builds up on the negative electrode surface. When the BET specific surface area of the graphite is small, the amount per unit area of the substance that builds up on the negative electrode surface resulting from migration away from the positive electrode also increases. To address this, by containing a silyl compound represented by a formula (1): (R1R2R3Si—O)ₘ-M=(O)ₙ in the non-aqueous electrolyte, the rise in the resistance can be suppressed.

In the formula (1), M is P, B or S, and n is 0, 1 or 2, and m is 2 or 3. Each of R1 to R3 is independently an alkyl group, a fluoroalkyl group, an alkenyl group, a fluoroalkenyl group, an aryl group, a fluoroaryl group, or a hydrogen atom.

The silyl compound represented by the formula (1) (hereinafter sometimes referred to as a silyl compound A) is considered to be preferentially decomposed at the positive electrode surface, forming a surface film having good ion conductivity that covers the positive electrode surface. This can suppress the oxidative decomposition of the non-aqueous electrolyte components at the positive electrode surface, leading to a less amount of the substance that migrates toward the negative electrode and builds up on the graphite surface, and thus, the rise in the resistance can be suppressed.

A description will be given below of a non-aqueous electrolyte secondary battery according to one embodiment of the present disclosure. Is to be noted, however, that the embodiment described below is just for illustration, and the present disclosure is not limited thereto.

The non-aqueous electrolyte secondary battery includes a positive electrode, a negative electrode, a non-aqueous electrolyte, a separator, and a battery case. For example, the positive electrode and the negative electrode are wound, with the separator interposed therebetween, forming an electrode body. The electrode body and the non-aqueous electrolyte are housed in the battery case. The electrode body may be a stacked-type electrode body formed by stacking the positive electrode and the negative electrode with the separator interposed therebetween, and may be an electrode body in a form other than the above.

The battery case for housing the electrode body and the non-aqueous electrolyte may be, for example, a metal case in a cylindrical shape, a prismatic shape, a coin shape, a button shape, or other shapes, or a pouch-like case formed of a resin sheet (laminated sheet) having a barrier layer, such as a metal foil.

[Positive Electrode]

The positive electrode includes a positive electrode current collector which is, for example, a metal foil, and a positive electrode active material layer formed on a surface of the positive electrode current collector. The positive electrode current collector may be a foil or other forms of a metal which is stable in a positive electrode potential range, such as stainless steel, aluminum, an aluminum alloy, and titanium. The positive electrode active material layer is usually formed of a positive electrode material mixture. The positive electrode material mixture includes a positive electrode active material, a binder, an electrically conductive agent, and the like.

The positive electrode active material layer can be formed by, for example, applying a slurry containing a positive electrode material mixture, onto a surface of the positive electrode current collector, followed by drying and then rolling the dry applied film. The thickness of the positive electrode current collector is, for example, 10 μm or more and 100 μm or less.

The positive electrode active material may be, for example, a lithium-containing transition metal oxide. Examples of the lithium-containing transition metal oxide include a layered compound having a rock-salt type crystal structure (e.g., a compound belonging to the space group R3-m), and a compound having a spinel type or perovskite type crystal structure. These positive electrode active materials may be used singly or in combination of two or more.

Examples of the lithium-containing transition metal oxide include LiₐCoO₂, LiₐNiO₂, LiₐMnO₂, LiₐCo_{b}Ni_{1-b}O₂, LiₐCo_{b}M_{1-b}O_{c}, LiₐNi_{1-b}M_{b}O_{c}, LiₐMn₂O₄, LiₐMn_{2-b}M_{b}O₄, LiMPO₄, and Li₂MPO₄F. Here, M is at least one selected from the group consisting of Na, Mg, Sc, Y, Mn, Fe, Co, Ni, Cu, Zn, Al, Cr, Pb, Sb, and B, and a=0 to 1.2, b=0 to 0.9, and c=2.0 to 2.3. The value “a” representing the molar ratio of lithium is subjected to increase and decrease during charge and discharge.

Preferred is a lithium-nickel composite oxide represented by LiₐNi_{b}M_{1-b}O₂, where M is at least one selected from the group consisting of Mn, Co, and Al, 0<a≤1.2, and 0.3≤b≤1. In view of achieving a higher capacity, b preferably satisfies 0.85≤b≤1. In view of the stability of the crystal structure, more preferred is LiₐNi_{b}Co_{c}Al_{d}O₂ containing Co and Al as elements represented by M, where 0<a≤1.2, 0.85≤b<1, 0<c<0.15, 0<d≤0.1, and b+c+d=1.

Examples of the conductive agent include carbon black, such as acetylene black and Ketjen black, and carbon powder, such as graphite. These may be used singly or in combination of two or more kinds.

Examples of the binder include a fluorocarbon resin and a rubbery material. Examples of the fluorocarbon resin include polytetrafluoroethylene (PTFE) and polyvinylidene fluoride (PVdF). Examples of the rubbery material include an ethylene-propylene-isoprene copolymer and an ethylene-propylene-butadiene copolymer. These may be used singly or in combination of two or more kinds. The binder may be used in combination with a thickener, such as carboxymethyl cellulose (CMC) and polyethylene oxide (PEO).

[Negative Electrode]

The negative electrode includes a negative electrode current collector which is, for example, a metal foil, and a negative electrode active material layer formed on a surface of the negative electrode current collector. The negative electrode current collector may be a foil or other forms of a metal which is stable in a negative electrode potential range, such as stainless steel, nickel, a nickel alloy, copper, and a copper alloy. The negative electrode active material layer is usually formed of a negative electrode material mixture. The negative electrode material mixture includes, for example, a negative electrode active material, a binder, and the like.

The negative electrode active material layer can be formed by, for example, applying a slurry containing a negative electrode material mixture, onto a surface of the negative electrode current collector, followed by drying and then rolling the dry applied film. The thickness of the negative electrode current collector is, for example, 5 μm or more and 40 μm or less.

The negative electrode active material may be any material that absorbs and releases lithium ions, but includes at least a graphite. Here, the graphite refers to, for example, a carbon material having a developed graphite crystal structure in which the average interplanar spacing d002 of the (002) plane as determined by X-ray diffractometry (XRD) is below 0.337 nm. The graphite is in a particulate form. In view of improving the cycle characteristics, for example, 50 mass % or more of the negative electrode active material is occupied by the graphite, and 75 mass % or more may be occupied by the graphite. The graphite may form a composite with an amorphous carbon. For example, carbon particles having a surface layer composed of an amorphous carbon and containing the graphite in its interior may be used. In the case of using particles in which the graphite and an amorphous carbon have formed a composite and are inseparable, the content of such particles in the negative electrode active material may satisfy the conditions above. Note that in the case of the particles formed of a composite of the graphite and an amorphous carbon, the mass ratio of the graphite in the particles is preferably higher than that of the amorphous carbon. Moreover, in the case of using two or more kinds of graphite, the content of the whole graphite in the negative electrode active material or the mass ratio of the whole graphite to the total of the whole graphite and the amorphous carbon may satisfy the conditions above.

The graphite has a BET specific surface area of 3 m²/g or less, and desirably 2 m²/g or less. By using a graphite with such a small BET specific surface area, the side reaction between the graphite and the non-aqueous electrolyte is suppressed, which can lead to improved cycle characteristics. The BET specific surface area of the graphite may be 1.8 m²/g or less, and may be 1.5 m²/g or less. The lower limit of the BET specific surface area is not specifically limited, but in view of securing sufficient output characteristics, the BET specific surface area is preferably 0.1 m²/g or more, and may be 0.4 m²/g or more. In the case of using particles in which the graphite and an amorphous carbon have formed a composite and are inseparable, the BET specific surface area of such composite particles may satisfy the conditions above. Moreover, in the case of using two or more kinds of graphite, the average BET specific surface area of the whole graphite may satisfy the conditions above.

The BET specific surface area of the graphite can be measured by any known method, and is measured, for example, based on the BET method, using a specific surface area measuring apparatus (e.g., available from Mountech Co., Ltd.). For example, the graphite separated from the negative electrode taken out from the battery is used as a measurement sample.

The graphite may be of any kind, examples of which include: natural graphite, such as lump graphite, earthy graphite, and flake graphite; lump or spherical artificial graphite; and graphitized mesophase carbon microbeads.

The graphite having a BET specific surface area as above can be obtained by, for example, reducing the exposed edge planes of the graphite crystal. The method of reducing the exposed edge planes of the graphite crystal includes, for example, applying an impact on the graphite, and applying a shearing force to the graphite. To be specific, a graphitized carbon material, that is, coarse graphite particles, is crushed in an inert atmosphere. The apparatus that can be used for crushing is, for example, a hammer mill, a pin mill, a jet mill, or a ball mill.

In order to reduce the exposed edge planes of the graphite crystal, the surface of the graphite particles may be coated with a coal- or petroleum-based pitch, and then subjected to heat treatment, thereby to cover the exposed edge planes with a carbonized pitch.

In the production process of the graphite, prior to graphitization treatment, a precursor of the graphite (e.g., a carbide, such as coke) may be subjected to crushing treatment, to adjust the particle size so as to have a predetermined particle size distribution. In the crushing treatment, the carbide may be mixed with a binder, such as a pitch. The exposed edge planes of the graphite crystal can be reduced also by subjecting the precursor having an adjusted particle size distribution to graphitization treatment. The temperature of the graphitization treatment is, for example, 1800° C. to 3000° C.

The graphite has a volume average particle diameter (i.e., median diameter) of, for example, 5 μm or more and 30 μm or less, which may be 10 μm or more and 25 μm or less. The volume average particle diameter refers to a particle diameter at 50% cumulative volume in a volumetric particle size distribution of the graphite as measured by, for example, a laser diffraction-scattering method. The volume average particle diameter can be measured using, for example, a laser diffraction-scattering type particle size distribution analyzer (e.g., available from MicrotracBEL Corp.).

The negative electrode active material may contain one or more other materials, in addition to the graphite. Example of such materials include: a carbon material, such as coke and a baked organic material; lithium titanate; a composite of a silicate and silicon; a metal oxide, such as SiO, SnO₂, SnO, and TiO₂; a metal, such as silicon and metal lithium; and a lithium alloy, such as a lithium-aluminum alloy, a lithium-silicon alloy, a lithium-tin alloy, and a titanium-silicon alloy.

Examples of the binder include, as in the case of the positive electrode, a fluorocarbon resin and a rubbery material, and the binder may be used in combination with a thickener. The rubbery material may be, for example, a styrene-butadiene copolymer (SBR) or a modified product thereof.

[Non-Aqueous Electrolyte]

The non-aqueous electrolyte usually contains a non-aqueous solvent and an electrolytic salt dissolved in the non-aqueous solvent, and includes a silyl compound (i.e., a silyl compound A) represented by a formula (1): (R1R2R3Si—O)ₘ-M=(O)ₙ. R1 to R3 are each bonded to a silicon atom. M=(O)ₙ represents oxygen double-bonded to M. R1 to R3 may be atoms or groups different from each other, and all of the three may be the same atoms or groups, or two of the three may be the same atoms or groups.

In the formula (1), M is P, B or S, n is 0, 1 or 2, m is 2 or 3, and each of R1 to R3 is independently an alkyl group, a fluoroalkyl group, an alkenyl group, a fluoroalkenyl group, an aryl group, a fluoroaryl group, or a hydrogen atom. The alkyl group and the fluoroalkyl group each have, for example, one to five carbon atoms (i.e., C1 to C5). The alkenyl group and the fluoroalkenyl group each have, for example, two to five carbon atoms (i.e., C2 to C5). The aryl group and the fluoroaryl group each have, for example, six to ten carbon atoms (i.e., C6 to C10). The fluoroalkyl group, the fluoroalkenyl group, and the fluoroaryl group may be a group in which at least one hydrogen atom is substituted by a fluorine atom, and may be a perfluorocarbon group in which all hydrogen atoms are substituted by fluorine atoms.

Examples of the alkyl group include a methyl group, an ethyl group, and a propyl group. Examples of the fluoroalkyl group include a trifluoromethyl group, a pentafluoro ethyl group, and a 2,2,2-trifluoro ethyl group. Examples of the alkenyl group include a vinyl group, a propenyl group, and an allyl group. Examples of the fluoroalkenyl group include a trifluorovinyl group and an α-fluorovinyl group. Examples of the aryl group include a phenyl group, a benzyl group, and a naphthyl group. Examples of the fluoroaryl include a monofluorophenyl group, a difluorophenyl group, and a trifluorophenyl group. For example, the R1R2R3Si—O— group may be a trimethylsilyl group or a tris(trifluoromethyl) silyl group in which R1 to R3 are all a methyl group or a trifluoromethyl group, and may be a triphenyl silyl group or a tris(fluorophenyl) silyl group in which R1 to R3 are all a phenyl group or a fluorophenyl group having at least one fluorine atom.

When M is P, a typical silyl compound A is exemplified by a tris-silyl phosphite compound, where n=0 and m=3, and a tris-silyl phosphate compound, where n=1 and m=3. To be specific, tris(trimethylsilyl) phosphite, tris(trimethylsilyl) phosphate, and the like are easily available.

When M is B, a typical silyl compound A is exemplified by a tris-silyl borate compound, where n=0 and m=3. To be specific, tris(trimethylsilyl) borate and the like are easily available.

When M is S, a typical silyl compound A is exemplified by a bis-silyl sulfate compound, where n=2 and m=2. To be specific, bis(trimethylsilyl) sulfate and the like are easily available.

The silyl compound A may be used singly or in combination of two or more kinds. In particular, the silyl compound A is preferably at least one selected from the group consisting of tris(trimethylsilyl) phosphite, tris(trimethylsilyl) phosphate, tris(trimethylsilyl) borate, and bis(trimethylsilyl) sulfate.

The silyl compound A is contained in the non-aqueous electrolyte in an amount of, for example, 2.5 mass % or less. In this case, a surface film having good ion conductivity can be formed so as to cover a sufficient area of the positive electrode surface. This can suppress the side reaction of the non-aqueous electrolyte at the positive electrode, leading to a less amount of the substance that migrates toward the negative electrode and builds up on the graphite surface, and thus, the rise in the negative electrode resistance can be suppressed.

The lower limit of the content of the silyl compound A in the non-aqueous electrolyte taken out from a shipped battery is not specifically limited, and may be as small as close to the detection limit. To put it differently, when the presence of the silyl compound A can be identified, sufficient action and effect can be observed. The shipped battery usually has been subjected to preliminary or initial charge and discharge before shipment. During such charge and discharge, the silyl compound A is decomposed preferentially on the positive electrode surface and consumed for the formation of a surface film. When the silyl compound A is present even slightly in the non-aqueous electrolyte taken out from the shipped battery, this means that the silyl compound remains without having been consumed completely.

On the other hand, in preparing or producing a non-aqueous electrolyte, the content of the silyl compound A is determined with taking into account the amount of the silyl compound A to be consumed for the formation of a surface film, so that the silyl compound A can remain in a sufficient amount in the battery after shipment. In the non-aqueous electrolyte before use for the battery production, or in the non-aqueous electrolyte taken out from the battery before the first charge and discharge, the silyl compound is desirably contained in an amount of, for example, 0.1 mass % or more and 2.5 mass % or less. When the content of the silyl compound is 0.1 mass % or more, a sufficient surface film can be formed on the positive electrode surface.

The content of the silyl compound A in the non-aqueous electrolyte can be determined by extracting the whole non-aqueous electrolyte in the battery using, for example, γ-butyrolactone (GBL), and measuring by gas chromatography mass spectrometry (GC-MS), nuclear magnetic resonance spectrometry (NMR), ion chromatography, and the like.

The non-aqueous solvent used in the non-aqueous electrolyte include, for example, esters, ethers, nitriles, and amides. These compounds may be a halogen substituted derivative in which at least one hydrogen atom is substituted by a halogen atom, such as a fluorine atom. These non-aqueous solvents may be used singly or in combination of two or more kinds. The non-aqueous electrolyte may be gelled and used as a polymer electrolyte, or may be a solid electrolyte.

Examples of the esters include a cyclic carbonate, a chain carbonate, and a carboxylic acid ester. Examples of the cyclic carbonate include ethylene carbonate (EC), propylene carbonate (PC), and butylene carbonate. Examples of the chain carbonate include dimethyl carbonate (DMC), ethyl methyl carbonate (EMC), diethyl carbonate (DEC), methyl propyl carbonate, ethyl propyl carbonate, and methyl isopropyl carbonate. Examples of the carboxylic acid ester include methyl acetate, ethyl acetate, propyl acetate, methyl propionate (MP), ethyl propionate, γ-butyrolactone (GBL), and γ-valerolactone (GVL).

Examples of the ethers include a cyclic ether and a chain ether. Examples of the cyclic ether include 1,3-dioxolane, 4-methyl-1,3-dioxolane, tetrahydrofuran, 2-methyl tetrahydrofuran, propylene oxide, 1,2-butylene oxide, 1,3-dioxane, 1,4-dioxane, 1,3,5-trioxane, furan, 2-methylfuran, 1,8-cineole, and crown ether. Examples of the chain ether include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, propionitrile, butyronitrile, valeronitrile, n-heptanenitrile, succinonitrile, glutaronitrile, adiponitrile, pimelonitrile, 1 ,2,3-propanetricarbonitrile, and 1,3,5-pentanetricarbonitrile.

Examples of the halogen substituted derivatives include a fluorinated cyclic carbonic ester, such as 4-fluoroethylene carbonate (FEC), a fluorinated chain carbonic ester, and a fluorinated chain carboxylic acid ester, such as methyl 3,3,3-trifluoropropionate (FMP).

The electrolytic salt preferably includes at least a lithium salt. Examples of the lithium salt include LiBF₄, LiClO₄, LiPF₆, LiAsF₆, LiSbF₆, LiAlCl₄, LiSCN, LiCF₃SO₃, LiC(C₂F₅SO₂), LiCF₃CO₂, Li(P(C₂O₄)F₄), Li(P(C₂O₄)F₂), LiPF₆₋ₓ(CₙF₂ₙ₊₁)ₓ, where 1≤x≤6, and n is 1 of 2, LiB₁₀Cl₁₀, LiCl, LiBr, LiI, chloroborane lithium, lithium lower aliphatic carboxylate, borates, such as Li₂B₄O₇, Li[B(C₂O₄)₂] (LiBOB: lithium bis(oxalate)borate), and Li[B(C₂O₄)F₂], phosphates, such as Li[P(C₂O₄)F₄] and Li[P(C₂O₄)₂F₂], and imides, such as LiN(FSO₂)₂ and LiN(CₘF₂ₘ₊₁SO₂)(CₙF₂ₙ₊₁SO₂), where m and n are each an integer of 0 or more). These lithium salts may be used singly or in combination of two or more kinds. Among them, LiPF₆, LiBF₄, LiClO₄, LiCF₃SO₃, LiN(FSO₂)₂, and the like are suitable as a major component of the lithium salt.

The content of the lithium salt in the non-aqueous electrolyte is, for example, 0.5 mol/liter or more and 3 mol/liter or less, and may be 1 mol/liter or more and 2 mol/liter or less.

[Separator]

A separator is usually interposed between the positive electrode and the negative electrode. The separator is excellent in ion permeability and has moderate mechanical strength and electrically insulating properties. The separator may be, for example, a macroporous thin film, a woven fabric, or a nonwoven fabric. The separator is preferably made of, for example, polyolefin, such as polypropylene or polyethylene.

FIG. 1 is a vertical cross-sectional view of a non-aqueous electrolyte secondary battery according to one embodiment of the present invention. A battery 100 as illustrated in FIG. 1 is an example of a cylindrical non-aqueous electrolyte secondary battery. A positive electrode 1 and a negative electrode 2 are wound, with a separator 3 interposed therebetween, forming an electrode body 4. The electrode body 4 is housed together with non-aqueous electrolyte (not shown) in the interior of a battery case 5. The opening of the battery case 5 is sealed, via a gasket 14, with a sealing unit 10. In the vicinity of the opening of the battery case 5, an annular recessed portion 5a protruding inward is formed, supporting the sealing unit 10. The positive electrode 1 is connected to a filter 13 via a positive electrode lead 8, and the negative electrode 2 is connected to the bottom of the battery case 5 via a negative electrode lead 9. An upper insulating plate 6 having a through-hole 6a at its center is placed on the top of the electrode body 4, and a lower insulating plate 7 is placed on the bottom side of the electrode body 4. The sealing unit 10 is a laminate formed of: a terminal plate 11 having a vent hole 11a; a valve member 12, which is a metal foil; a valve substrate 21 having a first airhole 12a; and the filter 13 having a second airhole 13a. The center portion of the valve substrate 21 serves as a welding portion 21a where the valve substrate is welded to the valve member 12. An annular PTC element 22 is interposed between the valve member 12 and the valve substrate 21.

The present invention will be specifically described below with reference to Examples and Comparative Examples. It is to be noted, however, the present invention is not limited to the following Examples.

### EXAMPLE 1, 2

[Production of Negative Electrode]

Coke and pitch were crushed and mixed together. The resultant mixture was baked at 1000° C., and then graphitized at 3000° C. The resultant coarse graphite particles were crushed with a ball mill in a N₂ atmosphere, and classified, to obtain graphite particles a1.

The BET specific surface area of the graphite particles a1 was measured using a specific surface area measuring apparatus (Macsorb (registered trademark) HM model-1201, available from Mountech Co., Ltd.). The BET specific surface area (simply denoted by “BET” in Table 1 below) of the graphite particles a1 was 1.4 m²/g.

The volume average particle diameter of the graphite particles a1 was measured using a laser diffraction-scattering type particle size distribution analyzer (MT3000, available from MicrotracBEL Corp.). The volume average particle diameter of the graphite particles a1 (simply denoted by “D50” in Table 1 below) was 16.1 μm.

First, 100 parts by mass of the graphite particles a1 serving as a negative electrode active material, 1 part by mass of carboxymethyl cellulose (CMC) serving as a thickener, 1 part by mass of styrene-butadiene copolymer (SBR) serving as a binder, and a predetermined amount of water were mixed together, to prepare a slurry including a negative electrode material mixture. Next, the slurry was applied onto both surfaces of a 10-μm-thick copper foil, and the applied film was dried, and then, rolled, to form a negative electrode active material layer having a thickness of 80 μm on both sides of the copper foil.

[Production of Positive Electrode]

First, 100 parts by mass of a lithium nickel composite oxide, LiNi_{0.8}Co_{0.15}Mn_{0.05}O₂, serving as a positive electrode active material, 1 part by mass of acetylene black serving as an electrically conductive agent, 0.9 parts by mass of polyvinylidene fluoride serving as a binder, and a predetermined amount of N-methyl-2-pyrrolidone (NMP) were mixed together, to prepare a slurry including a positive electrode material mixture. Next, the slurry was applied onto both surfaces of a 15-μm-thick aluminum foil, and the applied film was dried, and then, rolled, to form a positive electrode active material layer having a thickness of 70 μm on both sides of the aluminum foil.

[Preparation of Non-Aqueous Electrolyte]

In a non-aqueous solvent containing ethylene carbonate (EC), ethyl methyl carbonate (EMC), and dimethyl carbonate (DMC) in a volume ratio of 30:30:40 (at room temperature), LiPF₆ was dissolved as a lithium salt, and further, as a silyl compound A, tris(trimethylsilyl) phosphite was dissolved in Example 1, and tris(trimethylsilyl) phosphate was dissolved in Example 2, thereby to prepare a non-aqueous electrolyte. LiPF₆ was contained in the non-aqueous electrolyte at a concentration of 1.3 mol/L, and the silyl compound A was contained in an amount of 0.3 mass %.

[Fabrication of Non-Aqueous Electrolyte Secondary Battery]

Here, a 18650-type cylindrical non-aqueous electrolyte secondary battery with a rated capacity of 3200 mAh was fabricated in a structure as illustrated in FIG. 1. The positive electrode and the negative electrode were each cut in a predetermined size. With an aluminum lead and a nickel lead attached to the positive electrode and the negative electrode, respectively, the positive electrode and the negative electrode were wound with a separator made of polyethylene interposed therebetween, to form an electrode body. The electrode body was housed in a bottom-closed cylindrical battery case having an outer diameter of 18 mm and a height of 65 mm, into which a predetermined non-aqueous electrolyte was injected. Thereafter, the opening of the battery case was sealed with a gasket and a sealing body. In this way, a battery A 1 of Example 1 and a battery A2 of Example 2 were fabricated.

TABLE 1

| | | | | | | After 100 cycles at 45° C. | |
|---|---|---|---|---|---|---|---|
| | Graphite particles | | | Silyl compound A | | Percentage | Capacity |
| | Kind of | BET | D50 | Kind of | Content | increase in | retention |
| Battery | graphite | (m²/g) | (μm) | compound | (mass %) | DCIR (%) | ratio (%) |
| A1 | a1 | 1.4 | 16.1 | tris(trimethylsilyl) | 0.3 | 102.8 | 96.2 |
| | | | | phosphite | | | |
| A2 | a1 | 1.4 | 16.1 | tris(trimethylsilyl) | 0.3 | 104.1 | 96.1 |
| | | | | phosphate | | | |
| B1 | a1 | 1.4 | 16.1 | — | — | 106.6 | 96.1 |
| B2 | b1 | 3.9 | 22.0 | — | — | 100.6 | 95.2 |
| B3 | b1 | 3.9 | 22.0 | tris(trimethylsilyl) | 0.3 | 99.7 | 95.5 |
| | | | | phosphite | | | |

### COMPARATIVE EXAMPLE 1

A non-aqueous electrolyte was prepared in the same manner as in Example 1, except for using no silyl compound A, and a battery B1 of Comparative Example 1 was fabricated in the same manner as in Example 1.

### COMPARATIVE EXAMPLE 2

The coarse graphite particles obtained in Example 1 were crushed with a roller mill in air atmosphere, and classified, to obtain graphite particles b1. The BET specific surface area and the volume average particle diameter of the graphite particles b1 were measured each in a manner similarly to measuring those of the graphite particle a1. The result found that the BET specific surface area was 3.9 m²/g, and the volume average particle diameter was 22 μm.

A battery B2 of Comparative Example 2 was fabricated in the same manner as in Comparative Example 1 (i.e., using no silyl compound A), except that the graphite particles b1 were used in place of the graphite particles a1.

### COMPARATIVE EXAMPLE 3

A battery B3 of Comparative Example 3 was fabricated in the same manner as in Example 1 (i.e., using tris(trimethylsilyl) phosphite as the silyl compound A), except that the graphite particles b1 were used in place of the graphite particles a1.

[Analysis of Non-Aqueous Electrolyte in Battery]

Each of the completed batteries was subjected to an initial charge and discharge. Specifically, in a 25° C. temperature environment, a constant-current charge was performed at a current of 0.3 It until the voltage reached 4.1 V, which was subsequently followed by a constant-voltage charge performed at a constant voltage of 4.1 V until the current reached 0.02 It. Then, a constant-current discharge was performed at a current of 0.3 It until the voltage reached 3.0 V. Note that “1 It” is a current value at which the rated capacity can be discharged in one hour.

With the rest time between charge and discharge set to 10 minutes, the charge and discharge were performed five cycles in total under the above charge and discharge conditions. Thereafter, the battery was taken out and disassembled, to analyze the components of the non-aqueous electrolyte by NMR and GC-MS. As a result of the analysis, the presence of the silyl compound A was confirmed in each of the Examples.

The measurement conditions of GC used for the analysis of the non-aqueous electrolyte were as follows.

<Gas Chromatography Mass Spectrometry (GC-MS)>

Apparatus: GC-2010 Plus, available from Shimadzu Corporation

Column: HP-1 (1 μm×0.32 mm×60 m), available from J&W Corporation

Column temperature: 50° C.=>90° C. (hold 15 min, temperature rise rate: 5° C./min,)=>250° C. (hold 8 min, temperature rise rate: 10° C./min)

Split ratio: 1/50

Linear velocity: 30.0 cm/sec

Inlet temperature: 270° C.

Detector: FID 290° C. (sens. 10\hat{ }1)

Injection amount: 1 μL

The measurement conditions of NMR used for the analysis of the non-aqueous electrolyte were as follows.

<Nuclear Magnetic Resonance Spectrometry (NMR)>

Apparatus: ECX-400, available from JEOL RESONANCE Inc.

Solvent for measurement: Acetone-d6

Observation nucleus: 19 F

Observation frequency: 372.503 MHz

Pulse width: 2.2 μsec

Signal aquisition time: 3.5 sec

Repetition time: 20 sec

Accumulated number of times: 64 times

Furthermore, the batteries A1, A2, and B1 to B3 were evaluated in the following manner. The results are shown in Table 1.

[Initial DCIR]

In a 25° C. temperature environment, the battery was constant-current charged at a current of 0.3 It until the voltage reached 4.1 V, and subsequently, constant-voltage charged at a constant voltage of 4.1 V until the current reached 0.05 It. Thereafter, the battery was discharged at a constant current of 0.3 It for 100 minutes, to a state of charge (i.e., SOC) of 50%.

Next, the battery at 50% SOC was discharged for 10 seconds at a current value of 0 A, 0.1 A, 0.5 A, and 1.0 A, to acquire voltage data at these discharges. The relationship between the discharge current value applied and the voltage value after the 10 seconds was linearly approximated by a least-squares method, to determine the absolute value of the inclination, from which a DC resistance value (DCIR) was determined.

[Charge and Discharge Cycle Test]

In a 45° C. temperature environment, the battery was constant-current charged at a current of 0.5 It until the voltage reached 4.1 V, and subsequently, constant-voltage charged at a constant voltage of 4.1 V until the current reached 0.02 It. Thereafter, the battery was discharged at a constant current of 0.5 It until the voltage reached 3.0 V. This charge and discharge cycle was performed 100 cycles in total.

(Percentage Increase in DCIR)

In a 25° C. temperature environment, the battery having been subjected to 100 cycles was constant-current charged at a current of 0.3 It until the voltage reached 4.1 V, and subsequently, constant-voltage charged at a constant voltage of 4.1 V until the current reached 0.05 It. Thereafter, in a manner similar to the above, the battery was discharged to a state of charge (SOC) of 50%, and the battery at 50% SOC was discharged for 10 seconds at a current value of 0 A, 0.1 A, 0.5 A, and 1.0 A, to acquire voltage data at these discharges, from which a DCIR of the battery after cycling was determined.

The ratio of the DCIR after 100 cycles to the initial DCIR of each battery was calculated as a percentage increase in DCIR from the following formula.

Percentage increase in DCIR (%)=(DCIR at the 100th cycle/DCIR at the 1st cycle)×100

(Capacity Retention Ratio)

In the above charge and discharge cycles, the discharge capacity at the 1st cycle and the discharge capacity at the 100th cycle were checked, and a capacity retention ratio was determined from the following formula.

Capacity retention ratio (%)=(Discharge capacity at the 100th cycle/Discharge capacity at the 1st cycle)×100.

As shown in Table 1, the batteries A1, A2 and B1 including the graphite particle a1 having a BET specific surface area of 3 m²/g or less (specifically, 1.4 m²/g) exhibited a high capacity retention ratio, as compared to the batteries B2 and B3 including the graphite particle b1 having a BET specific surface area exceeding 3 m²/g (specifically, 3.9 m²/g). In the battery B1, however, the percentage increase in DCIR was considerably high. This is presumably because the surface film was thicky formed on the graphite surface, and the polarization increased. In contrast, in the batteries A1 and A2 in which the silyl compound A was contained in the non-aqueous electrolyte, the percentage increase in DCIR was significantly small as compared to in the battery B1, indicating that the increase in the resistance at the negative electrode was suppressed. This is presumably because the side reaction at the positive electrode was suppressed, and as a result, the amount built up on the graphite surface of the substance that migrated and reached the negative electrode was reduced.

In the battery B3 in which the silyl compound A was contained in the non-aqueous electrolyte, the percentage increase in DCIR was suppressed to be smallest by the inclusion of the graphite particles b1, but the capacity retention ratio was low, which was almost the same as or lower than that in the battery B2 including no silyl compound A.

It would be understood from the foregoing that, in order to achieve the improvement in the capacity retention ratio and the reduction in the DCIR at the same time, using a graphite with small BET specific surface area in combination with the silyl compound A is effective, and these two act synergistically.

### INDUSTRIAL APPLICABILITY

The non-aqueous electrolyte secondary battery according to the present disclosure is useful as a main power source for power storage systems, mobile communication devices, portable electronic devices, and other similar devices.

### REFERENCE SIGNS LIST

1 positive electrode

2 negative electrode

3 separator

4 electrode body

5 battery case

5a recessed portion

6 upper insulating plate

6a through-hole

7 lower insulating plate

8 positive electrode lead

9 negative electrode lead

10 sealing unit

11 terminal plate

11a vent hole

12 valve member

12a first airhole

13 filter

13a second airhole

14 gasket

21 valve substrate

21a welding portion

22 PTC element

100 battery

1. A non-aqueous electrolyte secondary battery, comprising:
a positive electrode, a negative electrode, a separator interposed between the positive electrode and the negative electrode, and a non-aqueous electrolyte, wherein
the negative electrode includes a graphite,
the graphite has a BET specific surface area of 3 m²/g or less,
the non-aqueous electrolyte includes a silyl compound represented by a formula (1): (R1R2R3Si—O)ₘ-M=(O)ₙ,
in the formula (1), M is P, B or S,
n is 0, 1 or 2,
m is 2 or 3, and
each of R1 to R3 is independently an alkyl group, a fluoroalkyl group, an alkenyl group, a fluoroalkenyl group, an aryl group, a fluoroaryl group, or a hydrogen atom.

2. The non-aqueous electrolyte secondary battery according to claim 1, wherein the silyl compound is at least one selected from the group consisting of tris(trimethylsilyl) phosphite, tris(trimethylsilyl) phosphate, tris(trimethylsilyl) borate, and bis(trimethylsilyl) sulfate.

3. The non-aqueous electrolyte secondary battery according to claim 1, wherein the silyl compound is contained in the non-aqueous electrolyte in an amount of 2.5 mass % or less.

4. The non-aqueous electrolyte secondary battery according to claim 1, wherein the graphite has a BET specific surface area of 2 m²/g or less.

5. A non-aqueous electrolyte for a secondary battery including a negative electrode including a graphite, the non-aqueous electrolyte comprising:
a silyl compound represented by a formula (1): (R1R2R3Si—O)ₘ-M=(O)ₙ,
in the formula (1), M is P, B or S,
n is 0, 1 or 2,
m is 2 or 3, and
each of R1 to R3 is independently an alkyl group, a fluoroalkyl group, an alkenyl group, a fluoroalkenyl group, an aryl group, a fluoroaryl group, or a hydrogen atom.

6. The non-aqueous electrolyte according to claim 5, wherein the silyl compound is at least one selected from the group consisting of tris(trimethylsilyl) phosphite, tris(trimethylsilyl) phosphate, tris(trimethylsilyl) borate, and bis(trimethylsilyl) sulfate.

7. The non-aqueous electrolyte according to claim 5, wherein the silyl compound is contained in the non-aqueous electrolyte in an amount of 0.1 mass % or more and 2.5 mass % or less.
